(19) United States
(12) Patent Application Publication
(10) Pub. No.: US 2010/0252497 A1
(43) Pub. Date: Oct. 7, 2010

(54) COMPOSITIONS FOR APPLYING TO HONEYCOMB BODIES

(76) Inventors: Adam J. Ellison, Painted Post, NY (US); Kimberly M. Keegan, Corning, NY (US); Paul J. Shustack, Elmira, NY (US); Patrick D. Tepesch, Corning, NY (US)

Correspondence Address: CORNING INCORPORATED, SP-TI-3-1, CORNING, NY, 14831, US

(21) Appl. No.: 12/741,083

(22) PCT Filed: Nov. 21, 2008
(86) PCT No.: PCT/US2008/013004

§ 371 Date: May 3, 2010

Related U.S. Application Data
(60) Provisional application No. 61/005,065, filed on Nov. 30, 2007.

(51) Int. Cl. C03C 6/00; B01D 35/00

(52) U.S. Cl. 210/500.1; 501/27

(57) ABSTRACT

Disclosed are compositions for applying to honeycomb substrates. The compositions comprise an inorganic powder batch composition; a binder; and a liquid vehicle. The inorganic powder batch composition comprises a ceramic forming glass powder. The compositions are well suited for use as plugging compositions for forming ceramic diesel particulate wall flow filters. Also disclosed herein are end plugged wall flow filters comprising the disclosed plugging compositions and methods for the manufacture thereof. The glass powder forms crystalline cordierite.

### CROSS REFERENCE TO RELATED APPLICATION

This Application claims the benefit of U.S. Provisional Application Ser. No. 61/005,065 filed Nov. 30, 2007 and entitled “Compositions for Applying to Honeycomb Bodies”.

### FIELD

The present invention relates to the manufacture of porous ceramic honeycomb bodies and, more particularly, to improved compositions and processes for sealing selected channels of porous ceramic honeycombs to form porous ceramic wall-flow filters therefrom.

### BACKGROUND

Ceramic wall flow filters are finding widening use for the removal of particulate pollutants from diesel or other combustion engine exhaust streams. A number of different approaches for manufacturing such filters from channeled honeycomb structures formed of porous ceramics are known. The most widespread approach is to position cured plugs of sealing material at the ends of alternate channels of such structures which can block direct fluid flow through the channels and force the fluid stream through the porous channel walls of the honeycombs before exiting the filter. The particulate filters used in diesel engine applications are typically formed from inorganic material systems, chosen to provide excellent thermal shock resistance, low engine back-pressure, and acceptable durability in use. The most common filter compositions are based on silicon carbide, aluminum titanate and cordierite. Filter geometries are designed to minimize engine back-pressure and maximize filtration surface area per unit volume. Illustrative of this approach is U.S. Pat. No. 6,809,139, which describes the use of sealing materials comprising cordierite-forming (MgO—Al₂O₃—SiO₂) ceramic powder blends and thermosetting or thermoplastic binder systems to form such plugs.

Diesel particulate filters typically consist of a parallel array of channels with every other channel on each face sealed in a checkered pattern such that exhaust gases from the engine would have to pass through the walls of the channels in order to exit the filter. Filters of this configuration are typically formed by extruding a matrix that makes up the array of parallel channels and then sealing or “plugging” every other channel with a sealant in a secondary processing step.

### SUMMARY

Aspects of the present invention provide improved compositions for applying to honeycomb bodies. The compositions can be applied as plugging compositions for forming ceramic wall flow filters. Alternatively, the compositions of the present invention can be applied to at least a portion of a honeycomb body as an after applied artificial skin coating. Still further, the composition of the instant invention can also be utilized as segment cements for joining two or more honeycomb bodies together. According to embodiments of the invention, the compositions can be sintered and ceramed at temperatures less than or equal to 1000° C. and may form a highly crystalline, durable, relatively low thermal expansion ceramic material with a relatively high melting point.

In one broad aspect, the present invention provides a composition for applying to a honeycomb body. According to some embodiments, the composition according to this aspect comprises an inorganic powder batch composition comprising a cordierite forming glass powder and a liquid vehicle. Further, the composition can be sintered and ceramed at a temperature T<950° C. to provide a ceramed crystalline phase cordierite composition having a coefficient of thermal expansion (CTE)≦25×10⁻⁷/° C.

In other embodiments according to this aspect, the composition comprises an inorganic powder batch composition comprising a cordierite forming glass powder that is at least substantially free of manganese. For example, in some embodiments, the cordierite forming glass powder consists on an oxide percent basis of 51% to 54% SiO₂; 13% to 18% MgO; and 28% to 35% Al₂O₃. The compositions further comprise an organic binder; and a liquid vehicle. According to embodiments, the composition can be sintered and ceramed at a temperature T≦1000° C. to provide a ceramed crystalline phase cordierite composition having a coefficient of thermal expansion (CTE)≦25×10⁻⁷/° C.

In still another broad aspect, the present invention provides a method for manufacturing a porous ceramic wall flow filter. The method according to this aspect comprises first providing a honeycomb structure defining a plurality of cell channels bounded by channel walls that extend longitudinally from an upstream inlet end to a downstream outlet end. An end portion of at least one predetermined cell channel is selectively plugged with a composition as described herein. The selectively plugged honeycomb body can then be fired at a temperature in the range of from 800° C. to 1000° C. for a period of time sufficient to form a crystalline ceramic plug in the at least one selectively plugged channel.

In still another broad aspect, the present invention provides a porous ceramic wall flow filters manufactured from the processes and plugging compositions described herein.

Additional embodiments of the invention will be set forth, in part, in the detailed description, and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

The accompanying drawings, which are incorporated in and constitute a part of this specification, illustrate certain embodiments of the instant invention and together with the description, serve to explain, without limitation, the principles of the invention.

FIG. 1 is an isometric view of porous honeycomb substrate according to embodiments of the invention.

FIG. 2a and FIG. 2b illustrate shrinkage dilatometry data for example compositions 13 through 17.

FIG. 3a and FIG. 3b illustrate a dL/dT versus temperature curve for the cordierite grog/glass mixtures of example compositions 13 through 17.

FIG. 4a and FIG. 4b illustrate shrinkage dilatometry data for an exemplary plugging composition comprising a cordierite grog/glass mixture wherein the ratio of grog to glass is 1:1.

FIG. 5a and FIG. 5b illustrate shrinkage dilatometry data for a first comparative plugging composition comprising cordierite grog in the absence of powdered glass.

FIG. 6a and FIG. 6b illustrate shrinkage dilatometry data for a second comparative plugging composition comprising a cordierite grog in the absence of powdered glass.

### DETAILED DESCRIPTION

The present invention can be understood more readily by reference to the following detailed description, drawings, examples, and claims, and their previous and following description. However, before the present compositions, articles, devices, and methods are disclosed and described, it is to be understood that this invention is not limited to the specific compositions, articles, devices, and methods disclosed unless otherwise specified, as such can, of course, vary. It is also to be understood that the terminology used herein is for the purpose of describing particular embodiments only and is not intended to be limiting.

The following description of the invention is provided as an enabling teaching of the invention in its best currently known embodiments. To this end, those skilled in the relevant art will recognize and appreciate that many changes can be made to the various embodiments of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

Disclosed are materials, compounds, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. Thus, if a class of substituents A, B, and C are disclosed as well as a class of substituents D, E, and F and an example of a combination embodiment, A-D is disclosed, then each is individually and collectively contemplated. Thus, in this example, each of the combinations A-E, A-F, B-D, B-E, B-F, C-D, C-E, and C—F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all embodiments of this disclosure including, but not limited to any components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

In this specification and in the claims which follow, reference will be made to a number of terms which shall be defined to have the following meanings:

As used herein, the singular forms “a,” “an” and “the” include plural referents unless the context clearly dictates otherwise. Thus, for example, reference to a “component” includes embodiments having two or more such components, unless the context clearly indicates otherwise.

“Optional” or “optionally” means that the subsequently described event or circumstance can or cannot occur, and that the description includes instances where the event or circumstance occurs and instances where it does not. For example, the phrase “optional component” means that the component can or can not be present and that the description includes both embodiments of the invention including and excluding the component.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used herein, a “wt. %” or “weight percent” or “percent by weight” of a component, unless specifically stated to the contrary, refers to the ratio of the weight of the component to the total weight of the composition in which the component is included, expressed as a percentage. “Oxide percent” may also be used to define the components of a composition. Oxide percent refers to the relative amounts of oxide components present in, for example, a ceramic powder such as cordierite powder or cordierite forming glass.

As used herein, a “superaddition” refers to a weight percent of a component, such as for example, an organic binder, liquid vehicle, or pore former, based upon and relative to 100 weight percent of an inorganic powder batch composition.

There may be three general types of plugging compositions in DPF manufacturing processes: 1) a post-firing composition (also called 2-step firing composition, or second fire composition); 2) co-firing composition (also called 1-step firing composition); and 3) cold set composition (prepared at ambient temperature and mostly used for plug repairs).

The post-firing or second fire composition may be used for plugging after the substrate has been fired. In general, these compositions may be comprised of aqueous or non-aqueous pastes or slurries of the same raw materials used to make the ceramic filter and/or the powder resulting from grinding up previously fired pieces of the ceramic filter (grog). A disadvantage of using the raw materials used to make the ceramic filters may be that the plug paste or slurry requires firing to the ceramic firing temperature (often>1400° C.). In particular, exposing an already-fired part to high firing temperatures can negatively affect its properties. In contrast however, a disadvantage of using ceramic grog may be that the ceramic grog has poor sintering ability.

Accordingly, there is a need in the art for improved plugging compositions for forming ceramic wall flow filters. In particular, there is a need for plugging compositions and methods to make plugging composition for DPF substrates that can be used in a second fire process and that can sinter at relatively low temperatures and still allow bonding of ceramic powder particles to each other and to the walls of the ceramic filter channels.

As briefly summarized above, in a first broad aspect the present invention provides compositions for applying to a honeycomb body. The compositions can be applied as plugging composition, segment cements, or even as after-applied artificial skins or coatings. The compositions are generally comprised of an inorganic powder batch composition; an organic binder; and a liquid vehicle. In embodiments, the organic binder may be optional. The inorganic powder batch composition comprises a ceramic forming glass powder, the presence of which enables the plugging compositions to be sintered and ceramed at a temperature T that does not exceed about 1000° C.

The ceramic forming glass powder present in the inorganic powder batch composition is preferably a cordierite ceramic forming glass powder, also referred to as cordierite glass. However, it should be understood that the present invention is not limited to the use of cordierite glass as other ceramic forming glass powders can be used as well. For example, beta-quartz glass, spodumene glass, and beta-eucryptite glass are additional ceramic forming glass compositions that can be used in the inorganic powder batch compositions of the present invention. According to some embodiments, it is preferred that the glass powder be a cordierite glass powder that is at least substantially free of manganese. According to embodiments, the ceramic forming glass powder may be cordierite forming glass powder and may have from 49 to 55 weight percent SiO₂ or, from 50 to 53 weight percent SiO₂; from 13 to 19 weight percent MgO or from 13 to about 18.5 weight percent MgO; and from 26 to 36 weight percent Al₂O₃ or from 28 to 35 weight percent Al₂O₃. According to other embodiments, it may be preferred for the cordierite glass powder to comprise, on a weight percent oxide basis, about 51% to about 54% SiO₂; about 13% to about 18% MgO; and about 28% to about 35% Al₂O₃. In addition to the cordierite components in the glass, it may be desirable to include other constituents to improve the manufacturing characteristics of the glass or to change its sintering behavior. Examples include but are not limited to Li, Na, K, oxides of Li, Na, K, Ca, Sr, La, Y and B. These oxides can be used to lower the devitrification temperature of the glass to ease manufacturing, to lower melting temperature, to change flow characteristics in the paste, and to adjust the degree of crystallinity of the final fired composition. These components may be preferably kept at a level of 0 to 5 weight percent and more preferably 0 to 2 weight percent.

The ceramic forming glass powder present in the inorganic powder batch composition can have any desired median particle size depending upon the desired properties of the resulting ceramed composition. However, according to some embodiments of the present invention, it is preferred for the ceramic forming glass powder to have a median particle size diameter dp₅₀ less than or equal to about 100 micrometers, 90 micrometers, 80 micrometers, 70 micrometers or 60 micrometers. In still other embodiments, it is preferred for the ceramic forming glass powder to have a median particle size diameter dp₅₀ less than or equal to about 50 micrometers, 40 micrometers, 30 micrometers, 20 micrometers or even 10 micrometers. In still further embodiments, it is preferred for the particle size diameter dp₅₀ of the ceramic forming glass powder to be in the range of from 8 to 12 micrometers, including particle size diameters of 9, 10, and 11 micrometers.

According to some embodiments, the inorganic powder batch composition can consist essentially of the ceramic forming glass powder as described above. However, in other embodiments, the inorganic powder batch composition can optionally comprise a mixture of the ceramic forming glass powder and one or more ceramed inorganic refractory powders, also referred to herein as a ceramic “grog.” Exemplary ceramic grog can include powders of silicon carbide, silicon nitride, cordierite, aluminum titanate, calcium aluminate, beta-eucryptite, and beta-spodumene, as well as refractory aluminosilicate fibers formed, for example, by the processing of aluminosilicate clay.

When present, the ceramic grog can have any desired median particle size, again depending upon the desired properties of the resulting ceramed composition. However, according to some embodiments of the present invention, it is preferred for the ceramic grog powder to have a median particle size diameter dp₅₀ less than or equal to about 100 micrometers, 90 micrometers, 80 micrometers, 70 micrometers or 60 micrometers. In still other embodiments, it is preferred for the ceramic grog to have a median particle size diameter dp₅₀ less than or equal to about 50 micrometers, 40 micrometers, 30 micrometers, 20 micrometers or even 10 micrometers. In still further embodiments, it is preferred that the ceramic grog have a median particle size dp₅₀ in the range of from about 40 micrometers to about 50 micrometers, including exemplary particle size diameters of 41, 43, 45, 47 and 49 micrometers.

Although the ceramic forming glass powder can be sintered and ceramed in the absence of added ceramic grog to provide a suitable ceramic composition, according to embodiments of the invention, the presence of the optional ceramic grog can be utilized to optimize one or more physical properties of the resulting ceramed composition. Further, the optimization can be achieved without significantly altering the coefficient of thermal expansion (CTE) of the resulting fired plug material. For example, increasing the relative amount of ceramic forming glass powder present in the composition will increase the amount of sintering that is required to fuse the ceramic forming glass particles together. In contrast, the ceramed grog particles will not sinter as they are already present in a ceramic form. Thus, by increasing the relative amount of ceramed grog present in the composition (i.e., a higher grog-to-glass weight ratio), the amount of sintering can be reduced. In turn, reducing the amount of sintering can yield less shrinkage during the firing process. However, the decreased shrinkage will also generally result in a corresponding decrease in the modulus of rupture strength of the resulting plug. Conversely, increasing the relative amount of ceramic forming glass (i.e., a lower grog-to-glass ratio) will generally result in more sintering. In turn, the increased sintering can yield increased levels of shrinkage during the firing process, but with a higher resulting modulus of rupture strength (MOR).

Therefore, it can be seen that by modifying the relative amounts of ceramic forming glass powder and the optional ceramic grog, a predetermined balance of overall shrinkage and strength for the resulting sintered and ceramed composition can be obtained. To that end, it should be understood that when the ceramic grog powder is present in the inorganic powder batch compositions, the ratio of ceramic grog to ceramic forming glass can be any desired ratio. For example, in an exemplary aspect, the weight ratio of ceramic grog to ceramic forming glass can be in the range of from 1:20 to 20:1. Alternatively, the weight ratio of ceramic grog to ceramic forming glass powder can be in the range of from 1:10 to 10:1. In still a further embodiment, the weight ratio of ceramic grog to ceramic glass can be in the range of from 1:4 to 4:1, including exemplary weight ratios of 1:2.5; 1:2, 1:1.5, 1:1, 1.5:1, 2:1, and 2.5:1.

To prepare the compositions of the instant invention, the inorganic powder batch composition as described above may be mixed together with an organic binder and a liquid vehicle in order to provide a flowable paste-like consistency to the composition. If desired, one or more optional processing aids can also be added to the composition.

The preferred liquid vehicle for providing a flowable or paste-like consistency to the plugging composition is water, although other liquid vehicles can be used. To this end, the amount of the liquid vehicle component can vary in order to provide optimum handling properties and compatibility with the other components in the batch mixture. According to some embodiments, the liquid vehicle content is usually present as a super addition in an amount in the range of from 15% to 60% by weight of the inorganic powder batch composition and, more preferably, according to some embodiment can be in the range of from 20% to 50% by weight of the inorganic powder batch composition. However, it should also be understood that in another embodiment, it can be desirable to utilize as little liquid vehicle component as possible while still obtaining a paste like consistency capable of, for example, being forced into selected ends of a honeycomb substrate to form end plugs therein. Minimization of liquid components in the compositions can also lead to further reductions in the drying shrinkage of the compositions during the drying process.

The addition of the optional organic binder component can further contribute to the cohesion and plasticity of the composition prior to firing. This improved cohesion and plasticity can, for example, improve the ability to shape the composition. This can be advantageous when utilizing the composition to form skin coatings or when plugging selected ends of a honeycomb body. Exemplary organic binders include water soluble cellulose ether binders such as methylcellulose, hydroxypropyl methylcellulose, methylcellulose derivatives, and/or any combinations thereof. Particularly preferred examples include methylcellulose and hydroxypropyl methylcellulose. An exemplary commercially available methylcellulose binder is Methocel™ A4M available from the Dow Chemical Company of Midland Mich., USA. Preferably, the organic binder can be present in the composition as a super addition in an amount in the range of from 0.1 weight percent to 5.0 weight percent of the inorganic powder batch composition and, more preferably, in an amount in the range of from 0.5 weight percent to 2.0 weight percent of the inorganic powder batch composition.

The compositions of the invention can optionally comprise at least one processing aid such as a plasticizer, lubricant, surfactant, sintering aid, rheology modifier, thixotropic agent, dispersing agents, or pore former. An exemplary plasticizer for use in preparing the plugging composition is glycerine. An exemplary lubricant can be a hydrocarbon oil or tall oil. Exemplary commercially available lubricant is Liga GS, available from Peter Greven Fett-Chemie and Durasyn® 162 hydrocarbon oil available from Innovene. A commercially available thixotropic agent is Benaqua 1000 available from Rheox, Inc. A pore former, may also be optionally used to optimize the porosity and median pore size of the resulting ceramed composition. Exemplary and non-limiting pore formers can include graphite, potato starch, polyethylene beads, and/or flour. Exemplary rheology modifiers can include organo-modified clays, gelling agents, thixotropes, and the like. A commercially available rheology modifier is Actigel™ 208, available from QCI Brittannic and Bentone® DE, available from Elementis. Exemplary dispersing agents that can be used include the NuoSperse® 2000 from Elementis and ZetaSperse® 1200, available from Air Products and Chemicals, Inc.

The addition of the optional sintering aid can enhance the strength of the ceramic plug structure after firing. Suitable sintering aids can generally include an oxide source of one or more metals such as strontium, barium, iron, magnesium, zinc, calcium, potassium, aluminum, lanthanum, yttrium, titanium, bismuth, or tungsten. In one embodiment, it is preferred that the sintering aid comprise one or more of B₂O₃, TiO₂, and K₂O. In another embodiment, it is preferred that the sintering aid comprise at least one rare earth metal. Still further, it should be understood that the sintering aid can be added to the composition in a powder or a liquid form.

Once formed, the compositions of the present invention can be fired under conditions effective to convert the batch composition into a primary crystalline phase ceramic composition. To that end, it has been discovered that the compositions described herein can be sintered and subsequently ceramed at firing temperatures T that are less than or equal to about 1000° C. For example, according to some embodiments, the compositions can be sintered and ceramed at a firing temperature in the range of from 800° C. to 1000° C., including exemplary firing temperatures of 825° C., 850° C., 875° C., 900° C., 925° C., 950° C., and 975° C. According to additional embodiments of the present invention, effective firing conditions for sintering and ceraming the compositions can comprise firing the composition at a temperature T that is less than 950° C. For example, according to these embodiments, the plugging composition can be fired at a temperature in the range of from 800° C. to 950° C., again including exemplary firing temperatures of 825° C., 850° C., 875° C., 900° C., 925° C.

If desired, the compositions can be dried prior to firing in order to substantially remove any liquid vehicle that may be present in the composition. As used herein, substantially all includes the removal of at least 95%, at least 98%, at least 99%, or even at least 99.9% of the liquid vehicle present in the plugging composition prior to drying. Exemplary and non-limiting drying conditions suitable for removing the liquid vehicle include heating the end plugged honeycomb substrate at a temperature of at least 50° C., at least 60° C., at least 70° C., at least 80° C., at least 90° C., at least 100° C., at least 110° C., at least 120° C., at least 130° C., at least 140° C., or even at least 150° C. for a period of time sufficient to at least substantially remove the liquid vehicle from the plugging composition. In one embodiment, the conditions effective to at least substantially remove the liquid vehicle comprise heating the plugging composition at a temperature in the range of from 60° C. to 120° C. Further, the heating can be provided by any conventionally known method, including for example, hot air drying, or RF and/or microwave drying.

Compositions for applying to honeycomb bodies, such as plugging compositions, segment cements, and artificial skins or coatings, typically exhibit coefficients of thermal expansion (CTE) that are greater than that of the ceramic honeycomb substrate upon which they are applied. It is believed that this is due to the lack of orientation that exists in the applied compositions compared to the composition of the honeycomb structure. Accordingly, it is desirable to provide compositions that can be applied to honeycomb bodies and which minimize and mismatch between the coefficients of thermal expansion. In particular, the inventive compositions can be developed to be close to the composition of the underlying honeycomb substrate to which the composition is applied. However, because forming methods are different for substrate and the paste compositions, the properties or features are still often different, such as shrinkage behavior during firing and CTE after firing. As noted above, the shrinkage of the inventive compositions can be controlled by modifications to the relative weight ratio of ceramic grog to ceramic forming glass powder. In addition, after firing, the resulting sintered and ceramed compositions preferably exhibit a coefficient of thermal expansion (CTE)≦25×10⁻⁷/° C. For example, according to some embodiments, the fired plugging compositions have a coefficient of thermal expansion (CTE) in the range of from 16×10⁻⁷/° C. to 21×10⁻⁷/° C., including exemplary CTE values of 17×10⁻⁷/° C., 18×10⁻⁷/° C., 19×10⁻⁷1° C., and 20×10⁻⁷/° C.

As further summarized above, in another broad aspect of the invention, the compositions described herein can be applied to a honeycomb body as plugging compositions to provide end plugged porous ceramic wall flow filters. In particular, in some embodiments these plugging compositions are well suited for providing end plugged ceramic honeycomb wall-flow filters. For example, in one embodiment, an end plugged ceramic wall flow filter can be formed from a honeycomb substrate that defines a plurality of cell channels bounded by porous channel walls that extend longitudinally from an upstream inlet end to a downstream outlet end. A first portion of the plurality of cell channels can comprise an end plug, formed from a plugging composition as described herein, and sealed to the respective channel walls at the downstream outlet end to form inlet cell channels. A second portion of the plurality of cell channels can also comprise an end plug, formed from a plugging composition as described herein, and sealed to the respective channel walls at the upstream inlet end to form outlet cell channels.

In still another broad aspect, the present invention provides a method for manufacturing a porous ceramic wall flow filter having a ceramic honeycomb structure and a plurality of channels bounded by porous ceramic walls, with selected channels each incorporating a plug sealed to the channel wall. The method generally comprises the steps of providing a honeycomb structure defining a plurality of cell channels bounded by porous channel walls that extend longitudinally from an upstream inlet end to a downstream outlet end and selectively plugging an end of at least one predetermined channel with a plugging composition as described herein. The selectively plugged honeycomb structure can then be fired under conditions effective to form a sintered phase ceramic plug in the at least one selectively plugged channel.

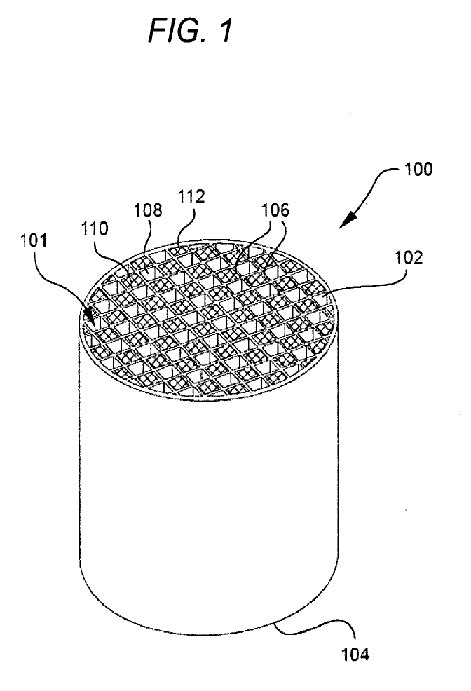

With reference to FIG. 1, an exemplary end plugged wall flow filter 100 is shown. As illustrated, the wall flow filter 100 preferably has an upstream inlet end 102 and a downstream outlet end 104, and a multiplicity of cells 108 (inlet), 110 (outlet) extending longitudinally from the inlet end to the outlet end. The multiplicity of cells is formed from intersecting porous cell walls 106. A first portion of the plurality of cell channels are plugged with end plugs 112 at the downstream outlet end (not shown) to form inlet cell channels and a second portion of the plurality of cell channels are plugged at the upstream inlet end with end plugs 112 to form outlet cell channels. The exemplified plugging configuration forms alternating inlet and outlet channels such that a fluid stream flowing into the reactor through the open cells at the inlet end 102, then through the porous cell walls 106, and out of the reactor through the open cells at the outlet end 104. The exemplified end plugged cell configuration can be referred to herein as a “wall flow” configuration since the flow paths resulting from alternate channel plugging direct a fluid stream being treated to flow through the porous ceramic cell walls prior to exiting the filter.

The honeycomb substrate can be formed from any conventional material suitable for forming a porous monolithic honeycomb body. For example, in one embodiment, the substrate can be formed from a plasticized ceramic forming composition. Exemplary ceramic forming compositions can include those conventionally known for forming cordierite, aluminum titanate, silica carbide, aluminum oxide, zirconium oxide, zirconia, magnesium, stabilized zirconia, zirconia stabilized alumina, yttrium stabilized zirconia, calcium stabilized zirconia, alumina, magnesium stabilized alumina, calcium stabilized alumina, titania, silica, magnesia, niobia, ceria, vanadia, nitride, carbide, or any combination thereof.

The honeycomb substrate can be formed according to any conventional process suitable for forming honeycomb monolith bodies. For example, in one embodiment a plasticized ceramic forming batch composition can be shaped into a green body by any known conventional ceramic forming process, such as, e.g., extrusion, injection molding, slip casting, centrifugal casting, pressure casting, dry pressing, and the like. Typically, a ceramic precursor batch composition comprises inorganic ceramic forming batch component(s) capable of forming, for example, one or more of the ceramic compositions set forth above, a liquid vehicle, a binder, and one or more optional processing aids including, for example, surfactants, sintering aids, plasticizers, lubricants, and/or a pore former. In an exemplary embodiment, extrusion can be done using a hydraulic ram extrusion press, or a two stage de-airing single auger extruder, or a twin screw mixer with a die assembly attached to the discharge end. In the latter, the proper screw elements are chosen according to material and other process conditions in order to build up sufficient pressure to force the batch material through the die. Once formed, the green body can be fired under conditions effective to convert the ceramic forming batch composition into a ceramic composition. Optimum firing conditions for firing the honeycomb green body will depend, at least in part, upon the particular ceramic forming batch composition used to form the honeycomb green body.

The formed monolithic honeycomb can have any desired cell density. In embodiments, the monolith 100 may have a cellular density from about 10 to 1000 cells/in² (1.6 to 155 cells/cm²). In additional embodiments, the monolith 100 may have a cellular density from about 70 cells/in² (10.9 cells/cm²) to about 400 cells/in² (62 cells/cm²). Still further, as described above, a portion of the cells 110 at the inlet end 102 are plugged with a paste having the same or similar composition to that of the body 101. The plugging is preferably performed only at the ends of the cells and form plugs 112 typically having a depth of about 5 to 20 mm, although this can vary. A portion of the cells on the outlet end 104 but not corresponding to those on the inlet end 102 may also be plugged in a similar pattern. Therefore, each cell is preferably plugged only at one end. The preferred arrangement is to therefore have every other cell on a given face plugged as in a checkered pattern as shown in FIG. 1. Further, the inlet and outlet channels can be any desired shape including but not limited to square, hexagonal, octagonal, rectangular, circular, oval, triangular, or combinations thereof. In the exemplified embodiment shown in FIG. 1, the cell channels are square shape.

The ceramic forming batch composition can be selected to as to yield a suitable ceramic honeycomb article which may cordierite, mullite, spinel, aluminum titanate, or a mixture thereof upon firing. For example, and without limitation, in one embodiment, the inorganic batch components can be selected to provide a cordierite composition consisting essentially of, as characterized in an oxide weight percent basis, from about 49 to about 53 oxide percent SiO₂, from about 33 to about 38 oxide percent Al₂O₃, and from about 12 to about 16 oxide percent MgO. To this end, an exemplary inorganic cordierite precursor powder batch composition preferably comprises about 33 to about 41 weight percent aluminum oxide source, about 46 to about 53 weight percent of a silica source, and about 11 to about 17 weight percent of a magnesium oxide source. Exemplary non-limiting inorganic batch component mixtures suitable for forming cordierite include those disclosed in U.S. Pat. Nos. 3,885,977; RE 38,888; 6,368,992; 6,319,870; 6,24,437; 6,210,626; 5,183,608; 5,258,150; 6,432,856; 6,773,657; 6,864,198; and U.S. Patent Application Publication Nos.: 2004/0029707; 2004/0261384.

Alternatively, in another embodiment, the inorganic batch components can be selected to provide, upon firing, a mullite composition consisting essentially of, as characterized in an oxide weight percent basis, from 27 to 30 percent by weight SiO₂, and from about 68 to 72 percent by weight Al₂O₃. An exemplary inorganic mullite precursor powder batch composition can comprise approximately 76% mullite refractory aggregate; approximately 9.0% fine clay; and approximately 15% alpha alumina. Additional exemplary non-limiting inorganic batch component mixtures suitable for forming mullite include those disclosed in U.S. Pat. Nos. 6,254,822 and 6,238,618.

Still further, the inorganic batch components can be selected to provide, upon firing, an alumina titanate composition consisting essentially of, as characterized in an oxide weight percent basis, from about 8 to about 15 percent by weight SiO₂, from about 45 to about 53 percent by weight Al₂O₃, and from about 27 to about 33 percent by weight TiO₂. An exemplary inorganic aluminum titanate precursor powder batch composition can comprises approximately 10% quartz; approximately 47% alumina; approximately 30% titania; and approximately 13% additional inorganic additives. Additional exemplary non-limiting inorganic batch component mixtures suitable for forming aluminum titanate include those disclosed in U.S. Pat. Nos. 4,483,944; 4,855,265; 5,290,739; 6,620,751; 6,942,713; 6,849,181; U.S. Patent Application Publication Nos.: 2004/0020846; 2004/0092381; and in PCT Application Publication Nos.: WO 2006/015240; WO 2005/046840; and WO 2004/011386.

When used as plugging compositions, the compositions of the present invention are well suited for use both as “single fire” and “second fire” plugging processes. In a “single fire” or “co-fire” process, the selectively end plugged honeycomb substrate is a formed green body or unfired honeycomb body comprised of a dried ceramic forming precursor composition as described above. The conditions effective to fire the plugging composition are also effective to convert the dried ceramic precursor composition of the green body into a sintered phase ceramic composition. Further according to this embodiment, the unfired honeycomb green body can be selectively plugged with a plugging composition having a composition that is substantially equivalent to the inorganic composition of the honeycomb green body. Thus, the plugging material can for example comprise either the same raw material sources or alternative raw material sources chosen to at least substantially match the drying and firing shrinkage of the green honeycomb.

Although the compositions of the present invention can be sintered and ceramed at firing temperatures less than or equal to 1000° C., the conditions effective to single fire the plugging composition and the green body will depend upon the composition of the formed honeycomb green body and the firing conditions needed to convert the composition of the green honeycomb body to a ceramic composition. According to some embodiments, a single fire process will comprise firing the selectively plugged honeycomb green body at a maximum firing temperature in the range of from 1350° C. to 1500° C., and more preferably at a maximum firing or soak temperature in the range of from 1375° C. to 1430° C. The maximum firing or soak temperature can, for example, be held for a period of time in the range of from 5 to 30 hours, including exemplary time periods of 10, 15, 20, or even 25 hours. Still further, the entire firing cycle, including the initial ramp cycle up to the soak temperature, the duration of the maximum firing or soak temperature, and the cooling period can, for example, comprise a total duration in the range of from about 100 to 150 hours, including 105, 115, 125, 135, or even 145 hours. According to embodiments of the invention, after firing is complete, the finished plugs will exhibit similar thermal, chemical, and/or mechanical properties to that of the fired honeycomb body.

A second fire plugging process comprises plugging a honeycomb substrate that has already been fired to provide a ceramic honeycomb structure prior to selectively end plugging the honeycomb substrate with the plugging composition of the present invention. To that end, the plugging composition as described herein can then be forced into selected open cells of the honeycomb substrate in the desired plugging pattern and to the desired depth, by one of several conventionally known plugging process methods. For example, selected channels can be end plugged as shown in FIG. 1 to provide a “wall flow” configuration whereby the flow paths resulting from alternate channel plugging direct a fluid or gas stream entering the upstream inlet end of the exemplified honeycomb substrate, through the porous ceramic cell walls prior to exiting the filter at the downstream outlet end.

The plugged honeycomb structure can then be fired under conditions effective to convert the plugging composition into a ceramic composition. As noted above, the compositions of the present invention can be sintered and ceramed at temperatures T that are less than or equal to about 1000° C. For example, according to some embodiments, the plugging composition can be fired at a temperature in the range of from 800° C. to 1000° C. including exemplary firing temperatures of 825° C., 850° C., 875° C., 900° C., 925° C., 950° C., and 975° C. According to additional embodiments of the present invention, effective firing conditions comprise firing the plugging composition at a maximum firing temperature T that is less than 950° C. For example, according to these embodiments, the plugging composition can be fired at a temperature in the range of from 800° C. to 950° C., again including exemplary firing temperatures of 825° C., 850° C., 875° C., 900° C., 925° C.

In still another embodiment, the compositions of the present invention are also suitable for use in applying an “after applied” or non co-extruded artificial skin or surface coating to an extruded honeycomb body. As one of ordinary skill in the art will appreciate, when honeycomb substrates are formed and dried, the resulting body may need to be resized or shaped in order to comply with desired size and shape tolerances for a given end use application. Accordingly, portions of the outer surface of a formed honeycomb body can optionally be removed by known methods such as sanding, grinding, and the like, in order to obtain a resulting body having a desired shape. After the removal of material from the surface of the body, the compositions of the present invention can be applied to the out surface in order to form an after applied skin to honeycomb body and to re-seal and honeycomb substrate channels that may have been exposed or breached due to the removal of material. Once the skin coating has been applied, the compositions can again be dried and fired as described herein.

In still another embodiment, the disclosed compositions can be applied as a segment cement in order to join two or more cellular honeycomb bodies. For example, the cements can be used to join two or more honeycomb bodies lengthwise or in an end to end relationship. Alternatively, the cements can be used to laterally join two or more cellular segments. For example, in some embodiments, it may be desirable to join two or more cellular honeycomb segments together laterally or in a side to side arrangement in order to form a larger cellular or honeycomb structure that may be too large for extrusion forming techniques described above. Once the segment cement has been applied to a honeycomb and the desired number of cellular segments has been joined, the segment composition can again be dried and fired as described herein.

### EXAMPLES

To further illustrate the principles of the present invention, the following examples are put forth so as to provide those of ordinary skill in the art with a disclosure and description of how the plugging compositions and methods claimed herein can be made and evaluated. They are intended to be purely exemplary of the invention and are not intended to limit the scope of what the inventors regard as their invention. Efforts have been made to ensure accuracy with respect to numbers (e.g., amounts, temperatures, etc.); however, some errors and deviations may have occurred. Unless indicated otherwise, parts are parts by weight, temperature is ° C. or is at ambient temperature, and pressure is at or near atmospheric.

### Examples 1-12

In the following example, 12 exemplary plugging compositions (1 through 12) according to the present invention were prepared comprising varying amounts of cordierite forming glass powder and, in some examples, the cordierite forming glass powder was combined with cordierite grog. Five different cordierite forming glass compositions were used in the examples, each having various stoichiometric percentages of the oxide components present in the glass composition. The powdered glass compositions had median particle size diameters of about 10 micrometers. The five glass compositions used are set forth in Table 1 below.

TABLE 1

| Glass | A | B | C | D | E |
|---|---|---|---|---|---|
| SiO₂ | 51.3% | 51.3% | 52.65% | 54% | 54.75% |
| MgO | 13.8% | 13.8% | 15.9% | 18% | 15.2% |
| Al₂O₃ | 34.9% | 34.9% | 31.45% | 28% | 30.05% |

Using these cordierite glass compositions, the specific formulations for the 12 inventive plugging compositions are set forth in Table 2 below. Compositions 1-12 were used to form 5/16″ rods that could be evaluated for shrinkage, coefficient of thermal expansion, modulus of rupture strength, and elastic modulus (young's modulus). The rods formed from compositions 1, 4, 5 and 9 were fired at 1000° C. under conditions where the ramp rate from 20° C. to 1000° C. was at 100° C./hour, followed by a hold at 1000° C. for three hours, followed by cool down from 1000° C. to 20° C. at a rate of 100° C. per hour. Compositions 2-3, 6-8, and 10-12 were fired according to a schedule comprising an initial ramp from 20° C. to 900° C. at 100° C. per hour, followed by a hold at 900° C. for about 4.4 hours, followed by another ramp from 900° C. to 1000° C. at a 100° C. per hour, followed by a cool down from 1000° C. to 20° C. at 100° C. hour.

The shrinkage, coefficient of thermal expansion, modulus of rupture strength, and elastic modulus (young's modulus) data are reported in Table 3.

TABLE 2

| | Batch Composition | | | | | | | | | | | |
|---|---|---|---|---|---|---|---|---|---|---|---|---|
| Ingredient | 1 | | 2 | | 3 | | 4 | | 5 | | 6 | |
| Cordierite Grog (45 μm) | 700.0 | g | 600.0 | g | 500.0 | g | 700.0 | g | 700.0 | g | 600.0 | g |
| Cordierite Glass A | 300.0 | g | 400.0 | g | 500.0 | g | | | | | | |
| Cordierite Glass B | | | | | | | 300.0 | g | | | | |
| Cordierite Glass C | | | | | | | | | 300.0 | g | 400.0 | g |
| Cordierite Glass D | | | | | | | | | | | | |
| Cordierite Glass E | | | | | | | | | | | | |
| Methocel A4M Binder | 23.4 | g | 46.8 | g | 46.8 | g | 23.4 | g | 23.4 | g | 46.8 | g |
| Liga GS Lubricant | 3.0 | g | 3.0 | g | 3.0 | g | 3.0 | g | 3.0 | g | 3.0 | g |
| Deionized Water | 380.0 | g | 361.0 | g | 329.4 | g | 380.0 | g | 380.0 | g | 343.0 | g |
| | Batch Composition | | | | | | | | | | | |
| Ingredient | 7 | | 8 | | 9 | | 10 | | 11 | | 12 | |
| Cordierite Grog (45 μm) | 500.0 | g | 400.0 | g | 700.0 | g | 600.0 | g | 500.0 | g | 600.0 | g |
| Cordierite Glass A | | | | | | | | | | | | |
| Cordierite Glass B | | | | | | | | | | | | |
| Cordierite Glass C | 500.0 | g | 600.0 | g | | | | | | | | |
| Cordierite Glass D | | | | | 300.0 | g | 400.0 | g | 500.0 | g | | |
| Cordierite Glass E | | | | | | | | | | | 400.0 | g |
| Methocel A4M Binder | 46.8 | g | 46.8 | g | 23.4 | g | 46.8 | g | 46.8 | g | 46.8 | g |
| Liga GS Lubricant | 3.0 | g | 3.0 | g | 3.0 | g | 3.0 | g | 3.0 | g | 3.0 | g |
| Deionized Water | 329.4 | g | 315.8 | g | 380.0 | g | 343.0 | g | 329.4 | g | 343.0 | g |

TABLE 3

| Composition | Grog/Glass | Glass | Shrinkage (%) | CTE @ 1000° C. | MOR (psi) | MOR Std. Dev. | E Mod (psi) |
|---|---|---|---|---|---|---|---|
| 1 | 70/30 | A | −0.5 | 17.5 × 10⁻⁷/° C. | 63.3 | 5.3 | |
| 2 | 60/40 | A | −0.15 | 16.4 × 10⁻⁷/° C. | 94.5 | 9.5 | |
| 3 | 50/50 | A | 0.1 | 17.0 × 10⁻⁷/° C. | 168.0 | 13.7 | |
| 4 | 70/30 | B | −0.6 | 18.3 × 10⁻⁷/° C. | 54.8 | 7.0 | |
| 5 | 70/30 | C | −0.55 | 17.8 × 10⁻⁷/° C. | 123.2 | 15.8 | |
| 6 | 60/40 | C | 0.1 | 16.5 × 10⁻⁷/° C. | 205.7 | 11.3 | |
| 7 | 50/50 | C | 1.25 | 18.4 × 10⁻⁷/° C. | 512.7 | 72.1 | 6.11 × 10⁵ |
| 8 | 40/60 | C | 2.2 | 18.2 × 10⁻⁷/° C. | 1097.1 | 148.0 | 1.17 × 10⁶ |
| 9 | 70/30 | D | −0.3 | 20.8 × 10⁻⁷/° C. | 164.9 | 10.0 | |
| 10 | 60/40 | D | 0.6 | 18.2 × 10⁻⁷/° C. | 324.3 | 24.2 | |
| 11 | 50/50 | D | 1.2 | 20.8 × 10⁻⁷/° C. | 599.0 | 59.0 | |
| 12 | 60/40 | E | 0.0 | 17.5 × 10⁻⁷/° C. | 268.9 | 17.6 | 3.06 × 10⁵ |

The data in Table 3 indicates that by decreasing the grog-to-glass ratio in the inventive plugging compositions increases both the percentage of shrinkage and the modulus of rupture strength upon firing. Conversely, increasing the grog-to-glass ratio in the inventive plugging compositions decreases both the percentage of shrinkage and the modulus of rupture strength upon firing. Further, it can also be seen that under both circumstances, the CTE of the fired rods remained in a relatively narrow and acceptable range of between 16×10⁻⁷/° C. to 21×10⁷1° C.

### Examples 13-17

In the following example, 5 additional exemplary plugging compositions (13 through 17) according to the present invention were prepared comprising varying amounts of stoichiometric cordierite forming glass powder and cordierite grog. The specific formulations for compositions 13-18 are set forth in Table 4 below.

TABLE 4

| | Batch Composition | | | | | | | | | |
|---|---|---|---|---|---|---|---|---|---|---|
| Ingredient | 13 | | 14 | | 15 | | 16 | | 17 | |
| Cordierite Grog | 0.00 | g | 20.00 | g | 40.00 | g | 60.00 | g | 80.00 | g |
| (325 mesh) | | | | | | | | | | |
| Cordierite Glass | 100.00 | g | 80.00 | g | 60.00 | g | 40.00 | g | 20.00 | g |
| (10 μm median) | | | | | | | | | | |
| Methocel A4M | 1.17 | g | 1.17 | g | 1.17 | g | 1.17 | g | 1.17 | g |
| Liga GS | 0.30 | g | 0.30 | g | 0.30 | g | 0.30 | g | 0.30 | g |
| DI Water | 35.00 | g | 35.00 | g | 35.00 | g | 35.00 | g | 35.00 | g |

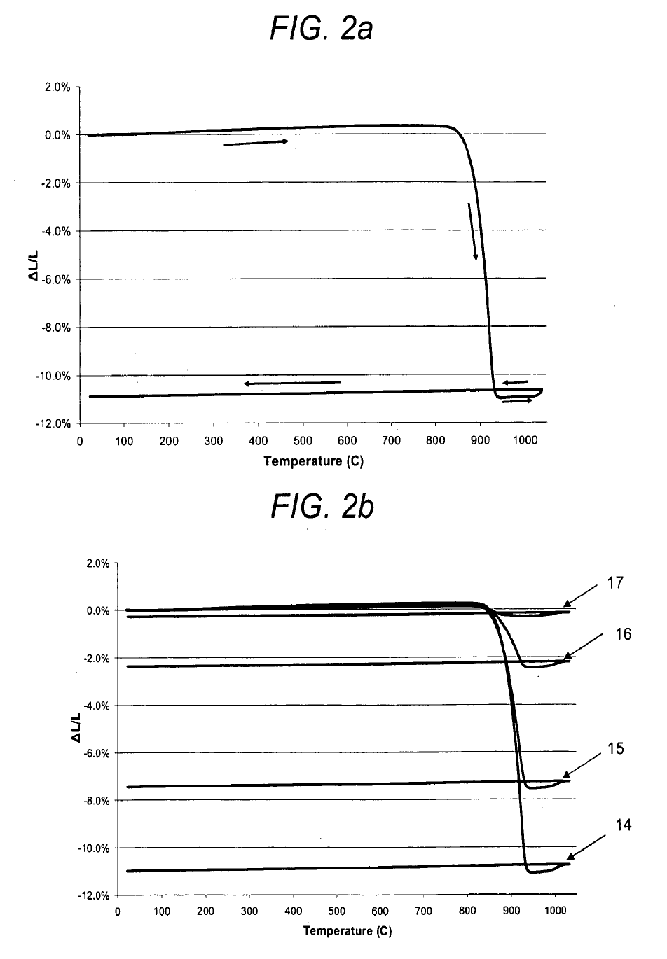

Shrinkage dilatometry experiments were conducted on compositions 13 through 17. FIG. 2a shows the shrinkage dilatometry data for composition 13, comprising the cordierite glass in the absence of any cordierite grog. In particular, the dilatometry data reflects the change in length upon heating relative to the initial length of a sample of a cordierite glass powder compact. Between approximately 800 and 950° C., the glass particles may soften resulting in shrinkage of the compact and formation of strong bonds between the particles. Between approximately 900 and 1000° C., the glass crystallizes, shrinkage stops, and the resulting crystallized composition has relatively low thermal expansion coefficient. The arrows indicate the progression of time in the experiment. FIG. 2b similarly shows the shrinkage dilatometry data for compositions 14 through 17 comprising pre-reacted cordierite powder (cordierite grog) in combination with varying amounts of cordierite forming glass powder (20 weight %, 40 weight %, 60 weight %, and 80 weight %). The data indicates that as more of the glass powder is replaced with cordierite powder, the overall shrinkage of the samples decreases, while the thermal expansion coefficient at the end of the heat-treatment remains relatively low. To that end, less shrinkage may be desired to reduce differential shrinkage of the applied compositions and the composition of the underlying honeycomb body.

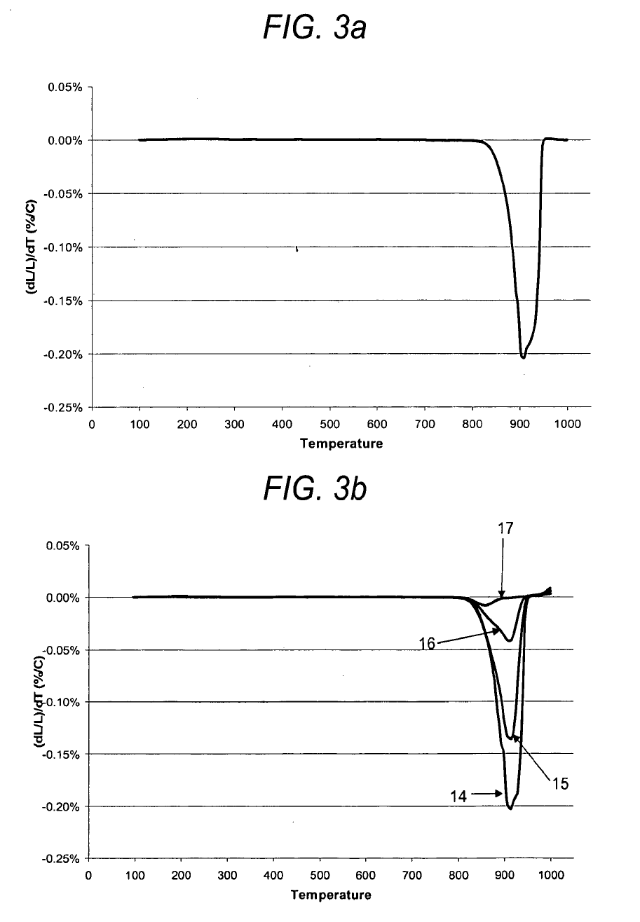

Still further, FIG. 3a is a derivative of FIG. 2a and provides the dL/dT versus temperature curve for the cordierite glass of composition 13. In particular, the data of FIG. 3a highlights the approximate temperature range in which the sintering due to the softening of the glass powder begins and ends, which in this example was in the range of about 850° C. to 950° C. Similarly, FIG. 3b is a derivative of FIG. 2b and provides the dL/dT versus temperature curves for the example compositions 14 though 17. In particular, the data of FIG. 3b indicates that irrespective of the varying weight ratios of glass to grog present in compositions 14 through 17, the sintering temperature remained substantially unchanged. However, as the cordierite grog-to-glass ratio increase, the dL/dT during the sintering of the composition (between 800° C. and 1000° C.) decreased.

### Examples 18-21

Four additional inventive plugging compositions (18-21) of the present invention were prepared and evaluated for their ability to plug honeycomb bodies to form wall flow filters. The specific batch compositions of the four plugging compositions are set forth in Table 5 below.

TABLE 5

| | Batch Compositions | | | | | | | |
|---|---|---|---|---|---|---|---|---|
| Ingredient | 18 | | 19 | | 20 | | 21 | |
| Cordierite Grog | 50.00 | g | 50.00 | g | 50.00 | g | 50.00 | g |
| (325 mesh) | | | | | | | | |
| Cordierite Glass (10 μm) | 50.00 | g | 50.00 | g | 50.00 | g | 50.00 | g |
| Binder (Methocel A4M) | 0.45 | g | 0.585 | g | 0.585 | g | 1.20 | g |
| Thixotrope | 0.15 | g | | | | | | |
| (Benaqua 1000) | | | | | | | | |
| Rheology Modifier | | | 1.00 | g | | | 0.30 | g |
| (Actigel 208) | | | | | | | | |
| Rheology Modifier | | | | | 0.15 | g | 0.30 | g |
| (Bentone DE) | | | | | | | | |
| Dispersant | 5.00 | g | 5.00 | g | 5.00 | g | | |
| (Nuosperse 2000) | | | | | | | | |
| Dispersant | | | | | | | 7.00 | g |
| (Zetasperse 1200) | | | | | | | | |
| DI Water | 38.30 | g | 36.00 | g | 38.30 | g | 37.00 | g |

Each of compositions 18, 19, 20, and 21 were used to plug already-fired aluminum titanate honeycomb monoliths. The plug paste materials were forced into the parts through a mask using a press. The plugged parts were then dried overnight at 60° C. then fired to 1000° C. The resulting parts had no visible cracks. Similarly, composition 20 was also used to plug a green cordierite honeycomb body. The plugged part was then dried and fired to a maximum soak temperature of 1410° C. and that temperature was held for approximately 24 hours. The resulting fired part also had no visible cracks.

### Example 22

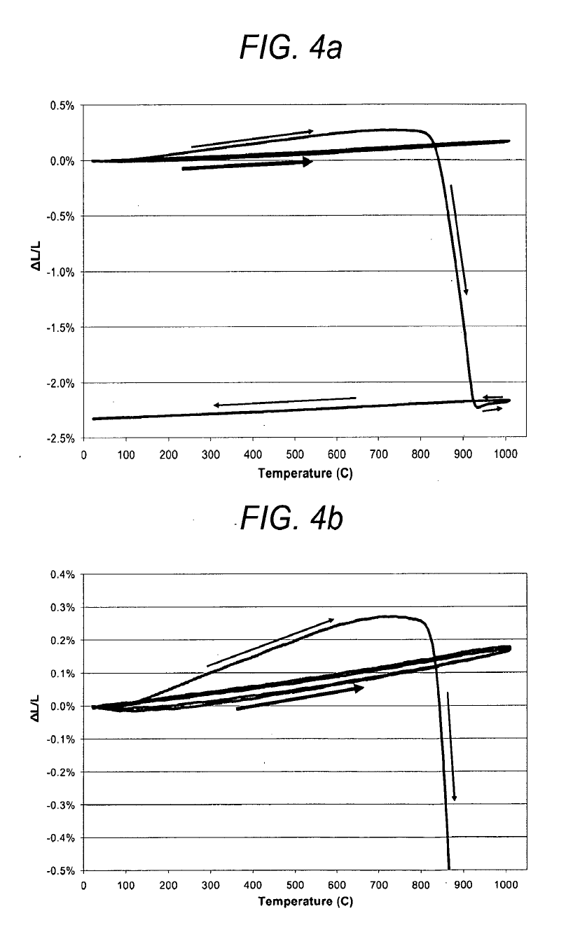

In this example, shrinkage dilatometry was evaluated for an exemplary plugging composition comprising a refractory cordierite powder (grog) and cordierite forming glass mixture wherein the ratio of cordierite grog to cordierite forming glass was 1:1. The composition was repetitively heated from room temperature to 1000° C. four separate times. The data from the evaluation is set forth in FIG. 4a and FIG. 4b. FIG. 4a shows the length change upon heating relative to the initial length of the sample on the first run (represented by the relatively thin arrows) and 3 subsequent heating cycles (represented by the bold arrow). On the first run the glass softened and sintered, bonding the particles together, followed by crystallization and then cooling. On the subsequent heating cycles, the final structure was very stable resulting in no further length changes other than thermal expansion. FIG. 4b further represents the data from FIG. 4a after having been zoomed on the y-axis to show the stability of the material during the subsequent heating cycles.

### Comparative Examples 1 and 2

In this example, shrinkage dilatometry was evaluated for two comparative plugging compositions comprising cordierite grog without the presence of the cordierite forming glass powder. The specific comparative plugging compositions are set forth in Tables 6 and 7 below.

TABLE 6

| Comparative 1 | Oxide Wt % | Grams | Weight % |
|---|---|---|---|
| Coarse Cordierite Grog | 50 | 500 | 39.68 |
| Fine Cordierite Grog | 30 | 300 | 23.81 |
| Pyrex Powder | 20 | 200 | 15.87 |
| Colloidal Silica | 25 | 250 | 19.84 |
| Organic Binder | 1 | 10 | 0.79 |
| DI Water | 24 | 240 | |

TABLE 7

| Comparative 2 | Oxide Wt % | Grams | Weight % |
|---|---|---|---|
| Coarse Cordierite Grog | 30.00 | 300.00 | 22.56 |
| Fine Cordierite Grog | 50.00 | 500.00 | 37.59 |
| Pyrex powder | 20.00 | 200.00 | 15.04 |
| Colloidal Silica | 25.00 | 250.00 | 18.80 |
| Organic Binder | 2.00 | 20.00 | 1.50 |
| Hydrocarbon Oil | 6.00 | 60.00 | 4.51 |

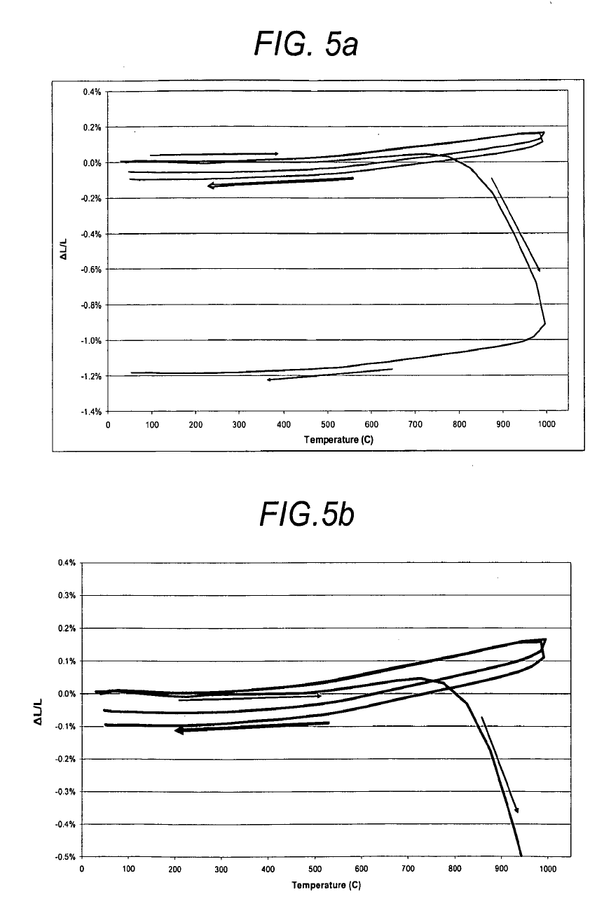

The shrinkage dilatometry data from the evaluation of the comparative example 1 is set forth in FIG. 5a and FIG. 5b. In particular, FIG. 5a shows the length change of comparative example 1 on the initial heating (represented by thin arrows) and compared to two subsequent heat treatments (represented by the thick arrow). It can be seen that the pyrex glass present in the composition may continue to soften on subsequent cycles leading to ongoing permanent changes in the dimensions, in addition to thermal expansion. FIG. 5b is the same plot as FIG. 5a but after being zoomed on the y-axis to the same scale as FIG. 4b discussed above. To that end, FIG. 5b further illustrates the continued dimensional changes of the pyrex-containing mixture on repeated heat-treatments.

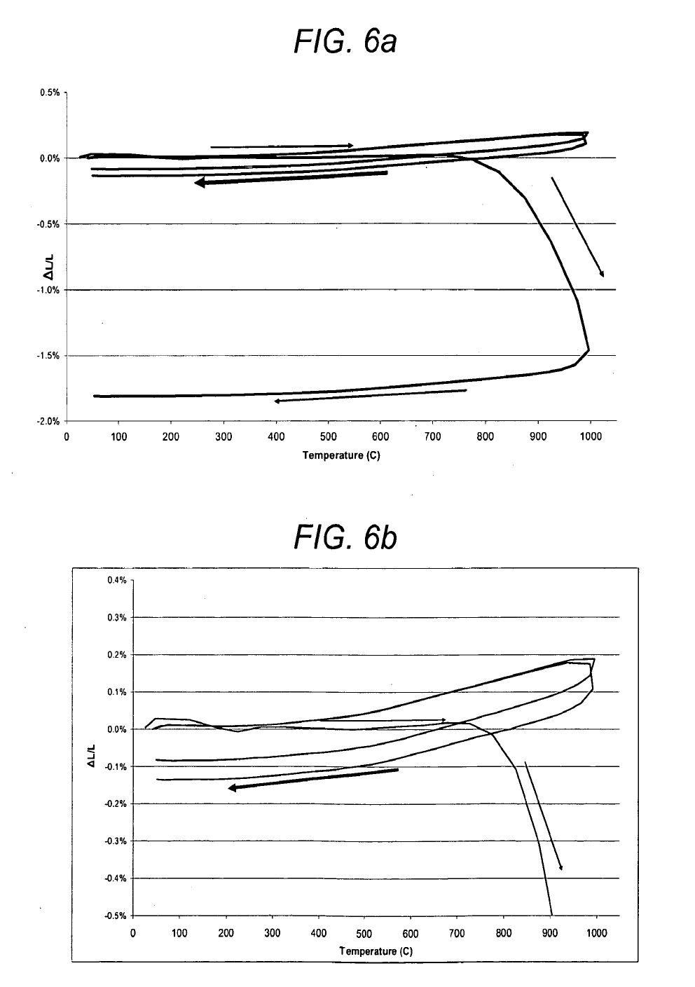

Similarly, the shrinkage dilatometry data from the evaluation of the comparative example 2 is set forth in FIG. 6a and FIG. 6b. In particular, FIG. 6a shows the length change of comparative example 2 on the initial heating (represented by thin arrows) and compared to two subsequent heat treatments (represented by the thick arrow). It can be seen that the pyrex glass present in the composition may continue to soften on subsequent cycles leading to ongoing permanent changes in the dimensions, in addition to thermal expansion. FIG. 6b is the same plot as FIG. 6a but after being zoomed on the y-axis to the same scale as FIG. 5b discussed above. To that end, FIG. 6b further illustrates the continued dimensional changes of the pyrex-containing mixture on repeated heat-treatments.

1. A composition for applying to a honeycomb body, comprising:
an inorganic powder batch composition comprising a cordierite forming glass powder, wherein the cordierite forming glass powder is substantially absent of manganese; and
a liquid vehicle;
wherein the composition can be sintered and ceramed to provide a ceramed crystalline phase cordierite composition having a coefficient of thermal expansion (CTE)≦ 25×10⁻⁷/° C.

2. The composition of claim 1, wherein the cordierite forming glass powder comprises, on an oxide percent basis, of:
49% to 55% SiO₂;
13% to 19% MgO; and
26% to 36% Al₂O₃.

3. The composition of claim 1, wherein the inorganic powder batch composition further comprises powdered cordierite.

4. The composition of claim 1, wherein the cordierite forming glass powder has a median particle size diameter dp₅₀ in the range of from 8 to 12 micrometers.

5. The composition of claim 3, wherein the powdered cordierite has a median particle size diameter dp₅₀ less than or equal to 50 micrometers.

6. The composition of claim 3, wherein the weight of the powdered cordierite is present in a ratio relative to the weight of powdered cordierite forming glass in a range of from 1:4 to 4:1.

7. The composition of claim 1, wherein the composition can be sintered and ceramed at a temperature T≦1000° C. to provide a ceramed crystalline phase cordierite composition having a coefficient of thermal expansion (CTE)≦ 25×10⁻⁷/° C.

8. The composition of claim 7, wherein the composition can be sintered and ceramed at a temperature T≦1000° C. to provide a ceramed crystalline phase ceramic composition having a coefficient of thermal expansion (CTE) in the range of from 16×10⁻⁷/° C. to 21×10⁻⁷1° C.

9. The composition of claim 7, wherein the temperature T is in the range of from 800° C. to 1000° C.

10. The composition of claim 1, wherein the composition further comprises at least one processing aid selected from a plasticizer, lubricant, surfactant, sintering aid, rheology modifier, and pore former.

11. The composition of claim 1, wherein the liquid vehicle comprises water.

12. The composition of claim 1, further comprising an organic binder.

13. The composition of claim 12, wherein the organic binder comprises a cellulose ether.

14. A composition for applying to a honeycomb body, comprising:
an inorganic powder batch composition comprising a cordierite forming glass powder; and
a liquid vehicle;
wherein the composition can be sintered and ceramed at a temperature T<950° C. to provide a ceramed crystalline phase cordierite composition having a coefficient of thermal expansion (CTE)≦ 25×10⁻⁷¹° C.

15. The composition of claim 14, wherein the cordierite forming glass powder comprises, on an oxide percent basis, of:
49% to 55% SiO₂;
13% to 19% MgO; and
26% to 36% Al₂O₃.

16. The composition of claim 14, wherein the inorganic powder batch composition further comprises powdered cordierite.

17. The composition of claim 16, wherein the weight of the powdered cordierite is present in a ratio relative to the weight of powdered cordierite forming glass in a range of from 1:4 to 4:1.

18. The composition of claim 14, wherein the composition can be sintered and ceramed at a temperature T≦950° C. to provide a ceramed crystalline phase ceramic composition having a coefficient of thermal expansion (CTE) in the range of from 16×10⁻⁷/° C. to 21×10⁻⁷/° C.

19. The composition of claim 14, wherein the composition further comprises at least one processing aid selected from a plasticizer, lubricant, surfactant, sintering aid, rheology modifier, and pore former

20. The composition of claim 14, wherein the liquid vehicle comprises water.

21. The composition of claim 14, further comprising an organic binder.

22. The composition of claim 21, wherein the organic binder comprises a cellulose ether.

23. A porous ceramic wall flow filter, comprising:
a honeycomb substrate defining a plurality of cell channels bounded by porous channel walls that extend longitudinally from an upstream inlet end to a downstream outlet end;
a first portion of the plurality of cell channels comprise a ceramed end plug sealed to the respective channel walls at the downstream outlet end to form inlet cell channels and a second portion of the plurality of cell channels comprise a ceramed end plug sealed to the respective channel walls at the upstream inlet end to form outlet cell channels;
wherein the ceramed end plugs are formed from a plugging composition comprising:
an inorganic powder batch composition comprising a cordierite forming glass powder, cordierite powder, and a liquid vehicle; wherein the plugging composition is sintered and ceramed at a temperature T 1000° C.

24. A method for manufacturing a porous ceramic wall flow filter, comprising the steps of:
providing a honeycomb structure defining a plurality of cell channels bounded by channel walls that extend longitudinally from an upstream inlet end to a downstream outlet end;
selectively plugging an end of at least one predetermined channel with a plugging composition comprising:
an inorganic powder batch composition comprising a cordierite forming glass powder comprising, on an oxide percent basis, of:
49% to 55% SiO₂;
13% to 19% MgO; and
26% to 36% Al₂O₃;
powdered cordierite, and
a liquid vehicle; and
firing the selectively plugged honeycomb body under conditions effective to convert the plugging composition into a crystalline phase cordierite plug in the at least one selectively plugged channel.

25. The method of claim 24, wherein the honeycomb body is a green body and wherein the step of firing the selectively plugged honeycomb body comprises heating the selectively plugged honeycomb body under conditions effective to convert the green honeycomb body into a ceramic honeycomb body.
